(19) United States
(12) Patent Application Publication
(10) Pub. No.: US 2012/0232896 A1
(43) Pub. Date: Sep. 13, 2012

(54) METHOD AND AN APPARATUS FOR VOICE ACTIVITY DETECTION

(75) Inventors: Anisse TALEB, Stockholm (SE); Zhe WANG, Beijing (CN); Jianfeng XU, Munchen (DE); Lei MIAO, Beijing (CN)

(73) Assignee: HUAWEI TECHNOLOGIES CO., LTD., Shenzhen (CN)

(21) Appl. No.: 13/476,896

(22) Filed: May 21, 2012

Related U.S. Application Data
(63) Continuation of application No. PCT/CN2010/080217, filed on Dec. 24, 2010.

(51) Int. Cl. G10L 15/20; G10L 15/00

(52) U.S. Cl. 704/233; 704/231; 704/E15.001; 704/E15.039

(57) ABSTRACT

A voice activity detection apparatus (1) comprising: a signal condition analyzing unit (3) which analyses at least one signal parameter of an input signal to detect a signal condition SC of said input signal; at least two voice activity detection units (4-i) comprising different voice detection characteristics, wherein each voice activity detection unit (4-i) performs separately a voice activity detection of said input signal to provide a voice activity detection decision VADD; and a decision combination unit (5) which combines the voice activity detection decisions VADDs provided by said voice activity detection units (4-i) depending on the detected signal condition SC to provide a combined voice activity detection decision cVADD.

### CROSS-REFERENCE TO RELATED APPLICATIONS

This application is a continuation of International Application No. PCT/CN2010/080217, filed on Dec. 24, 2010, which is hereby incorporated by reference in its entirety.

### FIELD OF THE INVENTION

The present invention relates to a method and an apparatus for voice activity detection and in particular for detecting a presence or absence of human speech in an audio signal applied to an audio signal processing unit such as an encoder.

### BACKGROUND OF THE INVENTION

Voice activity detection (VAD) is generally a technique which is provided to detect a voice activity in a signal. Voice activity detection is also known as speech activity detection or simply speech detection. Voice activity detection can be used in speech applications in which a presence or absence of human speech is detected. Voice activity detection can for example be used in speech coding or speech recognition. Since voice activity detection is relevant for a variety of speech based applications various VAD algorithms have been developed that provide varying features and compromises between requirements such as latency, sensitivity, accuracy and computational complexity. Some voice activity detection (VAD) algorithms also provide an analysis of data, for example whether a received input signal is voiced, unvoiced or sustained. Voice activity detection is performed for an input audio signal which comprises input signal frames. Voice activity detection can be performed by voice activity detection units which label input signal frames with a corresponding flag indicating whether speech is present or not.

A conventional voice activity detection (VAD) apparatus has a performance which depends on the specific condition of the received input signal and a signal type or signal category of the respective received signal. The signal type can comprise a speech signal, a music signal and a speech signal with background noise. Furthermore, the signal condition of a signal can vary, for example a received audio signal can have a high signal to noise ratio SNR or a low signal to noise ratio SNR. When receiving an input audio signal a conventional voice activity detection apparatus may be suited for the received input signal and can give an accurate (VAD) decision. However, depending on the signal category and the signal condition a conventional voice activity detector can also provide poor results, i.e. it can have a low voice detection accuracy when detecting a voice activity of an applied input signal. Moreover, the signal condition and signal type of the applied input signal can change over time and therefore a conventional voice activity detection apparatus is not robust against signal type or signal condition changes or variations.

Accordingly, it is a goal of the present invention to provide a method and an apparatus for performing a voice activity detection leading to an overall better detection performance than with a conventional voice activity detection method or apparatus.

### SUMMARY OF THE INVENTION

According to a first aspect of the present invention a voice activity detection apparatus is provided comprising
a signal condition analyzing unit which analyzes at least one signal parameter of an input signal to detect a signal condition of said input signal,
at least two voice activity detection units comprising different voice detection characteristics,
wherein each voice activity detection unit performs separately a voice activity detection or voice activity detection processing of said input signal to provide a voice activity detection decision; and
a decision combination unit which combines the voice activity detection decisions provided by said voice activity detection units depending on the detected signal condition to provide a combined voice activity detection decision.

Each voice activity detection unit has certain detection characteristics. The detection characteristics have close relationship in concept with the receiver operating characteristic (ROC). In signal detection theory, a receiver operating characteristic (ROC), or simply ROC curve, is a graphical plot of the sensitivity, or true positive rate, vs. false positive rate for a binary classifier system as its discrimination threshold is varied. For a voice detection system, the true positive rate is the active detection rate and the false positive rate is the inactive misdetection rate. The detection characteristic of a voice activity detection system can be regarded as a special ROC curve with the varying discrimination threshold replaced by varying signal condition. A signal condition can be defined as a certain combination of multi-conditions such as input signal level, input signal SNR, background noise type of the input signal, voice activity factor of the input signal etc. Thus, voice detection characteristics, i.e. detection vs. misdetection (also known as false alarm) is different for different input signals. In general, two voice activity detection units will have different voice activity detection characteristics if their decisions are different for at least one instance of an input signal. Thus for a certain signal condition, the performance of the two VADs will be different.

For example, different characteristics can be obtained for different voice activity detection algorithms if they are tuned differently, or can be obtained from the same algorithm by changing, even slightly, the parameters that the algorithm uses such as thresholds, the number of frequency bands used for analysis etc.

In a possible implementation of the first aspect of the present invention the voice activity detection apparatus comprises a signal input for receiving an input signal comprising signal frames.

In a possible implementation of the first aspect of the present invention the voice activity detection units are formed by signal to noise ratio based voice activity detection units.

The use of signal to noise ratio based voice activity detection units increases the accuracy and performance of the voice activity detection apparatus according to the present invention.

In a possible implementation of the first aspect of the present invention each SNR based voice activity detection unit divides the input signal frame into several sub-frequency bands.

In a possible implementation of the first aspect of the present invention each SNR based voice activity detector unit processes the input signal on a frame-by-frame basis.

By calculating a signal to noise ratio SNR for each sub-band of the input frame the accuracy of the voice activity detection apparatus according to the present invention is further increased.

In a further possible implementation of the first aspect of the present invention each signal to noise ratio SNR based voice activity detection unit divides the input signal frame into sub-frequency bands and calculates a signal to noise ratio SNR for each sub-frequency band wherein the calculated signal to noise ratios SNRs of all sub-frequency bands are summed up to provide a segmental signal to noise ratio SSNR.

In a further possible implementation of the first aspect of the present invention the segmental signal to noise ratio SSNR calculated by a voice activity detection unit is compared with a threshold to provide an intermediate voice activity detection decision of the respective voice activity detection unit,

wherein the intermediate voice activity detection decision or a processed version thereof forms the voice activity detection decision.

Accordingly, an intermediate voice activity detection decision is made by each voice activity detection unit of the voice activity detection apparatus based on a comparison between a segmental signal to noise ratio SNR and a corresponding threshold.

In a possible implementation the threshold of a voice activity detection unit is adaptive and can be adjusted by means of a corresponding control signal applied to the voice activity detection apparatus by means of a configuration interface. Since every voice activity detection unit within the voice activity detection apparatus comprises a corresponding adaptive threshold value which can be adjusted via the interface a fine or precise tuning of the performance of each of the different voice activity detection units is possible. This in turn again increases the accuracy of the voice activity detection apparatus according to the present invention.

In a further possible implementation of the first aspect of the present invention each signal to noise ratio SNR calculated for a corresponding sub-frequency band is modified by applying a non-linear function to the signal to noise ratio SNR to provide a corresponding modified signal to noise ratio mSNR, wherein the modified signal to noise ratios mSNR are summed up by the respective voice activity detection unit to obtain the segmented signal to noise ratio SSNR.

The provision of a non-linear function allows to modify the signal to noise ratio SNR in different ways for providing different voice activity detection characteristics for the different voice activity detection units, thus making it possible to provide an accurate tuning of the different voice activity detection units and to adapt their respective voice detection characteristics to the specific possible signal conditions and/or signal types of the received input audio signal.

In a possible implementation of the first aspect of the present invention the intermediate voice activity detection decision of each voice activity detection unit is passed through a hangover process with a corresponding hangover time to provide a final voice activity decision of said voice activity detection unit.

The hangover time forms a waiting time period to smooth the voice activity detection decision and to reduce potential misclassifications by the voice activity detection units associated with clipping at the tail of a talk spurt within the received audio signal. Accordingly, an advantage of this specific implementation resides in that clipping of talk spurts is reduced and that speech quality and intelligibility of the signal is improved.

In a possible implementation of the first aspect of the present invention the voice detection characteristic of each voice activity detection unit within the voice activity detection apparatus is tuneable for example by means of a configuration interface.

In a possible implementation of the first aspect of the present invention the voice detection characteristic of each voice activity detection unit is tuneable by adapting or changing the number of sub-frequency bands used by the respective voice activity detection unit.

In a further possible implementation of the first aspect of the present invention the voice detection characteristic of each voice activity detection unit is tuneable by adapting or changing the non-linear function used by the respective voice activity detection unit.

In a further possible implementation of the first aspect of the present invention the voice detection characteristic of each voice activity detection unit is tuneable by adapting or changing a hangover time of the hangover process used by the respective voice activity detection unit.

In a further possible implementation of the first aspect of the present invention the apparatus comprises different voice activity detection units which are implemented in different ways, e.g. by different numbers of sub-frequency bands or frequency decomposition and which may use different methods to calculate sub-band signal to noise ratios, apply different modifications to the calculated sub-band signal to noise ratios and which may use different methods or ways to estimate sub-band energies for background noises and which further can use different thresholds or apply different hangover mechanisms. Therefore, the different voice activity detection units have different performances for different signal conditions of the received input audio signal. One voice activity detection unit can be superior to another voice activity detection unit for one signal condition but may be worse for another signal condition. Besides for a given signal condition one voice activity detection unit may perform better than another voice activity detection unit for one segment of the input audio signal but may be worse for another segment of the input audio signal. By providing different voice activity detection units each performing separately a different voice activity detection of the input signal to provide a voice activity detection decision the overall performance is improved by properly combining the merits of the multiple voice activity detection units.

In a possible implementation of the first aspect of the present invention the signal condition analyzing unit analyzes as the signal parameter of the input signal a long term signal to noise ratio of the input signal to detect the signal condition of the received input signal.

In a further possible implementation of the first aspect of the present invention the signal condition analyzing unit analyzes as the signal parameter of the input signal a background noise fluctuation of the received input signal to detect the signal condition of the received input signal.

In a still further possible implementation of the first aspect of the present invention the signal condition analyzing unit analyzes as the signal parameter of the received input signal a long term signal to noise ratio and a background noise fluctuation of the input signal to detect the signal condition of the received input signal. It is possible that the long term signal to noise ratio is the signal to noise ratio of several active signal frames of the received input signal, for example of 5-10 active signal frames or the moving average of the signal to noise ratios of active signal frames of the received input signal. The moving average can be calculated by SNRₘₒᵥ=a*SNRₘₒᵥ+(1−a)*SNR₀, where SNRₘₒᵥ is the moving average, SNR₀ is the SNR of the latest active signal frame, a is a forgetting factor which can be 0.9 in for long term estimation.

In a further possible implementation of the first aspect of the present invention the signal condition analyzing unit analyzes as the signal parameter of the received input signal a signal state indicating whether the current signal is during an active period or an inactive period.

In a further implementation of the first aspect of the present invention the signal condition analyzing unit analyzes as the signal parameter of said input signal an energy metric of the input signal. The signal condition analyzing unit may be further adapted to determine that the input signal is during or in an active period if the energy metric is greater than a predetermined or adaptive threshold, and/or to determine that the input signal is during or in an inactive period if the energy metric is smaller than the predetermined or adaptive threshold, respectively.

In further possible implementations of the first aspect of the present invention the signal condition analyzing unit can use other signal parameters or a combination of signal parameters as well such as tonality, spectrum tilt or spectrum envelope of the signal spectrum of the received input signal.

In a possible implementation of the first aspect of the present invention the voice activity detection decisions provided by said voice activity detection units are formed by decision flags.

In a possible implementation of the first aspect of the present invention the decision flags generated by the voice activity detection units are combined according to combination logic of the decision combination unit to provide the combined voice activity detection decision which can be output by the voice activity detection apparatus according to the present invention.

In a possible implementation of the first aspect of the present invention said signal parameter analyzed by said signal condition analyzing unit is the long term signal to noise ratio which is categorized into three different signal to noise ratio regions comprising a high SNR region, a medium SNR region and a low SNR region, wherein said combined voice activity detection decision is provided by said decision combination unit on the basis of the decision flags provided by said voice activity detection units depending on the SNR region in which the long term signal to noise ratio falls.

In a possible implementation of the first aspect of the present invention, the voice activity detection apparatus comprises a first voice activity detection unit with a first voice activity detection characteristic and a second voice activity detection unit with a second voice activity detection characteristic, wherein the first voice activity detection characteristic is different to the second voice activity detection characteristic, wherein the first voice activity detection unit performs a first voice activity detection of or on the input signal to provide a first voice activity detection, wherein the second voice activity detection unit performs a second voice activity detection of or on the input signal to provide a second voice activity detection, wherein said signal parameter analyzed by said signal condition analyzing unit is the long term signal to noise ratio which is categorized into three different signal to noise ratio regions comprising a high SNR region, a medium SNR region and a low SNR region, wherein said combined voice activity detection decision is provided by said decision combination unit depending on the SNR region in which the long term signal to noise ratio falls, and wherein the decision combination unit is adapted to select the first voice activity detection decision as combined voice activity detection decision in case the signal parameter is in the low SNR region, wherein the decision combination unit is adapted to select the second voice activity detection decision as combined voice activity detection decision in case the signal parameter is in the high SNR region, and wherein the decision combination unit is adapted to apply a logic AND or a logic OR combination of the first voice activity detection decision and the second voice activity detection decision to obtain the combined voice activity detection decision in case the signal parameter is in the medium SNR region.

In a possible implementation of the first aspect of the present invention the combined voice activity detection decision provided by the decision combination unit is passed through a hangover process with a predetermined hangover time.

This allows to smooth the voice activity detection decision and to reduce further possible misclassifications by the voice activity detection units associated for example with clipping of a talk spurt.

In a possible implementation of the first aspect of the present invention the combined voice activity decision provided by the voice activity detection apparatus is applied to an encoder. This encoder can be formed by a speech encoder.

In a further possible implementation of the first aspect of the present invention a voice activity detection decision vector comprising the voice activity detection decisions provided by the voice activity detection units is multiplied by the decision combination unit with an adaptive weighting matrix to calculate the combined voice activity detection decision.

In a still further possible implementation of the first aspect of the present invention the weighting matrix used by said decision combination unit is a predetermined weighting matrix with predetermined matrix values.

In a possible implementation of the first aspect of the present invention a segmental signal to noise ratio SSNR vector comprising the segmental signal to noise ratios SSNRs of the voice activity detection units is multiplied with an adaptive weighting matrix to calculate a combined segmental signal to noise ratio cSSNR value.

In a still further possible implementation of the first aspect of the present invention a threshold vector comprising the threshold values of the voice activity detection units is multiplied with the adaptive weighting matrix to calculate a combined decision threshold value.

In a still further possible implementation of the first aspect of the present invention the calculated combined segmental signal to noise ratio mSSNR value and the combined decision threshold value are compared with each other to provide the combined voice activity detection decision.

In use of vectors such as the voice activity decision vector, the weighting matrix as well as the segmental signal to noise ratio vector and the threshold vector can speed up the calculation process and reduces the required calculation time for providing the combined voice activity detection decision and can also provide more accurate tuning to the voice activity detection apparatus.

According to a second aspect of the present invention, a voice activity detection apparatus is provided, the voice activity detection apparatus comprising: a signal condition analyzing unit, which analyses at least one signal parameter of an input signal to detect a signal condition of said input signal; at least two voice activity detection units comprising different activity voice detection processing characteristics, and a decision combination unit adapted to provide a combined voice activity detection decision (cVADD), wherein a segmental signal to noise ratio (SSNR) vector comprising the segmental signal to noise ratios (SSNRs) of the voice activity detection units is multiplied with an adaptive weighting matrix to calculate a combined segmental signal to noise ratio (cSSNR) value, and wherein a threshold vector comprising the threshold values of the voice activity detection units is multiplied with the adaptive weighting matrix to calculate a combined decision threshold value (cthr), which is compared to said calculated combined segmental signal to noise ratio (cSSNR) value to provide the combined voice activity detection decision (cVADD).

According to a third aspect of the present invention an encoder for encoding an audio signal is provided wherein said encoder comprises a voice activity detection apparatus having
a signal condition analyzing unit which analyzes at least one signal parameter of an input signal to detect a signal condition of said input signal,
at least two voice activity detection units comprising different voice detection characteristics,
wherein each voice activity detection unit performs separately a voice activity detection of said input signal to provide a voice activity detection decision and
a decision combination unit which combines the voice activity detection decisions provided by said voice activity detection units depending on the detected signal condition to provide a combined voice activity detection decision.

According to a fourth aspect of the present invention a speech communication device is provided comprising a speech encoder for encoding an audio signal, said speech encoder having a voice activity detection apparatus comprising:
a signal condition analyzing unit which analyzes at least one signal parameter of an input signal to detect a signal condition of said input signal,
at least two voice activity detection units comprising different voice detection characteristics,
wherein each voice activity detection unit performs separately a voice activity detection of said input signal to provide a voice activity detection decision, and
a decision combination unit which combines the voice activity decisions provided by said voice activity detection units depending on the detected signal condition to provide a combined voice activity detection decision.

The speech communication device can form part of a speech communication system such as an audio conferencing system, a speech recognition system, a speech encoding system or a hand free mobile phone. The speech communication device according to the fourth aspect of the present invention can be used in a cellular radio system, for instance a GSM or LTE or CDMA system wherein a discontinuous transmission DTX mode can be controlled by the voice activity detection VAD apparatus according to the first aspect of the present invention. In the discontinuous transmission DTX mode it is possible to switch off circuitry during time periods where the absence of a human speech is detected by the voice activity detection apparatus to save resources and to enhance the system capacity, for example by reducing code channel interference and power consumption in portable devices.

In the above implementations the voice activity detection receives a digital audio signal which can consist of signal frames each comprising digital audio samples. In these implementation forms the voice activity detection apparatus perform the signal processing in the digital domain. The processing in the digital domain has the benefit that the signal processing can be performed by hardwired digital circuits or by software application routines performing the processing of the received digital audio input signal. Processing the signal frames of the received input audio signal can be performed by a voice activity detection program executed by a processing unit such as a microcomputer. This microcomputer can be programmable by means of a corresponding interface providing more flexibility.

According to a fifth aspect of the present invention a method for performing a voice activity detection is provided comprising the steps of:
analyzing at least one signal parameter of an input signal to detect a signal condition of the input signal,
performing separately a voice activity detection with at least two different voice detection characteristics to provide different voice activity detection decisions, and
combining the voice activity detection decisions depending on the detected signal condition to provide a combined voice activity detection decision.
The method for performing a voice activity detection according to the fifth aspect is robust against external influences.

In a possible implementation of the fifth aspect of the present invention the method is performed by executing a corresponding voice activity detection program which can be executed by a microcomputer. In a further possible implementation the method for performing a voice activity detection is performed by a hardwired circuitry. Performing the method with a hardwired circuitry provides the advantage that the processing speed is very high. The implementation of the method for performing a robust voice activity detection by means of a software program has the benefit that the method is more flexible and easier to be adapted to different signal conditions and signal types.

In further possible implementation forms of the aforementioned aspects of the present invention the voice activity detection units may be formed by non-SNR based voice activity detection units. Such non-SNR based voice activity detection units can be—but are not limited to—entropy based voice activity detection units, spectral envelope based voiced activity detection units, higher statistics based voice activity detection units, hybrid voice activity detection units etc. In contrast to SNR based voice activity detection units, for instance the entropy based voice activity detection unit divides the input frame spectrum into sub-bands, calculates the energy of each sub-band, computes the probability of the input frame energy that is distributed in each sub-band and computes the entropy of the input frame based on obtained probabilities. The voice activity decision is then obtained by comparing the obtained entropy to a threshold.

Possible implementations and embodiments of different aspects of the present invention are described in the following with reference to the enclosed figures.

### BRIEF DESCRIPTION OF THE DRAWINGS

FIG. 1 shows a block diagram for illustrating a voice activity detection apparatus according to a first aspect of the present invention;

FIG. 2 shows a block diagram illustrating an encoder connected to a voice activity detection apparatus according to a second aspect of the present invention;

FIG. 3 shows a flow chart for illustrating a possible implementation of a voice activity detection method according to a fourth aspect of the present invention.

### DETAILED DESCRIPTION OF THE EMBODIMENTS

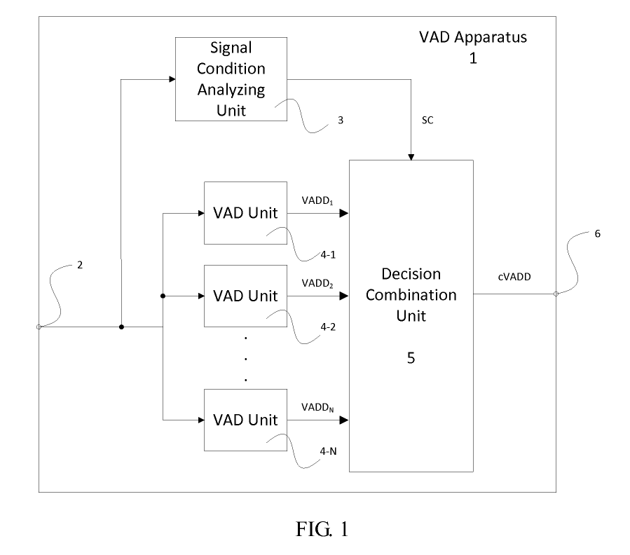

FIG. 1 shows a block diagram of a voice activity detection apparatus 1 to illustrate a first aspect of the present invention. The voice activity detection apparatus 1 comprises at least one signal input 2 for receiving an input signal. This input signal is for example an audio signal consisting of signal frames. The audio signal can be a digital signal formed by a sequence of signal frames each comprising at least one data sample of an audio signal. The applied digital signal can be supplied by an analogue digital converter connected to a signal source, for example a microphone of a speech communication device such as a user equipment device or a mobile phone.

The voice activity detection apparatus 1 comprises in the shown implementation a signal condition analyzing unit 3 which analyzes at least one signal parameter of the applied input signal to detect a signal condition of the respective input signal. The voice activity detection apparatus 1 as shown in FIG. 1 comprises several voice activity detection units 4-1, 4-2, . . . , 4-N, wherein N is an integer ≧2. which are connected to the signal input 2 of the voice activity detection apparatus 1. Each i-th (i being an integer) voice activity detection unit 4-i performs separately a voice activity detection of the applied input signal to provide a corresponding voice activity detection decision VADD. In a possible implementation the voice activity detection apparatus 1 comprises at least two voice activity detection units 4-1, 4-2. The voice activity detection apparatus 1 further comprises a decision combination unit 5 which combines the voice activity detection decisions VADDs provided by the voice activity detection units 4-i depending on the detected signal condition SC to provide a combined voice activity detection decision cVADD. This combined voice activity detection decision cVADD is output by the voice activity detection apparatus 1 at signal output 6 as shown in FIG. 1.

In a possible implementation of the voice activity detection apparatus 1 as shown in FIG. 1 the voice activity detection units 4-i are formed by signal to noise ratio (SNR) based voice activity detection units. In a possible implementation all voice activity detection units 4-i are formed by signal to noise ratio (SNR) based voice activity detection units. In a further possible implementation at least a portion of the voice activity detection units 4-i is formed by signal to noise ratio (SNR) based voice activity detection units. Each signal to noise ratio (SNR) based voice activity detection unit 4-i divides in a possible implementation an input signal frame of the received input signal into sub-frequency bands. The number of sub-frequency bands can vary. The signal to noise ratio (SNR) based voice activity detection unit 4-i further calculates a signal to noise ratio SNR for each sub-frequency band and sums the calculated signal to noise ratios SNRs of all sub-frequency bands up to provide a segmental signal to noise ratio SSNR which can be compared with a threshold to provide an intermediate voice activity detection decision output provided by the respective voice activity detection unit 4-i to the decision combination unit 5. In a possible implementation the threshold value compared with the calculated segmental signal to noise ratio SSNR can be an adaptive threshold value which can be changed or adapted by means of a configuration interface of the voice activity detection apparatus 1. In a possible implementation the voice detection characteristic of each voice activity detection unit 4-i of the voice activity detection apparatus 1 as shown in FIG. 1 is tuneable. In a possible implementation the number of sub-frequency bands used by a voice activity detection unit 4-i can be adapted. For example, a voice activity detection unit 4-i can divide an input signal frame into nine sub-bands by using for example a filter bank. Further, a voice activity detection unit 4-i can transform the input frame into the frequency domain by a fast fourier transformation FFT and divide the input frame into for example nineteen sub-frequency bands by partitioning the FFT power density bins.

In a possible implementation of the voice activity detection apparatus 1 as shown in FIG. 1 each signal to noise ratio SNR being calculated for a corresponding sub-frequency band can be modified by applying a non-linear function to the signal to noise ratio SNR to provide a modified signal to noise ratio mSNR. These modified signal to noise ratios mSNRs can be summed up to obtain the segmental signal to noise ratio SSNR. The provision of a non-linear function allows to tune the voice detection characteristic of the respective voice activity detection unit 4-i. In a possible implementation the voice detection characteristic of each voice activity detection unit is tuneable by changing a non-linear function used by the respective voice activity detection unit 4-i.

In a still further implementation of the voice activity detection apparatus 1 as shown in FIG. 1 the intermediate voice activity detection decision of each voice activity detection unit 4-i can be passed through a corresponding hangover process with a corresponding hangover time to provide a final voice activity detection decision of the voice activity detection unit 4-i which can be supplied by the voice activity detection unit 4-i to the following decision combination unit 5. In a possible implementation the hangover process is performed within the voice activity detection unit 4-i. In a further possible implementation the hangover process is performed within the decision combination unit 5 for each received voice activity detection decision VADD. In a still further possible implementation the hangover process for the intermediate voice activity detection decision is performed by a separate hangover processing unit provided between the respective voice activity detection unit 4-i and the decision combination unit 5.

In a possible implementation of the voice activity detection apparatus 1 the voice activity detection characteristic of each voice activity detection unit 4-i is tuneable by adapting a hangover time of the hangover process used by the respective voice activity detection unit 4-i. Other implementations are possible. For example the different voice activity detection unit 4-i of the voice activity detection apparatus 1 as shown in FIG. 1 can have different numbers of sub-bands or frequency decompositions and can use different methods to calculate sub-band signal to noise ratios, apply different modifications to the calculated sub-band signal to noise ratios and use different methods or ways to estimate the sub-band energies for background noises. Furthermore, the voice activity detection unit 4-i can use different thresholds and apply different hangover mechanisms.

In a possible implementation of the voice activity detection apparatus 1 as shown in FIG. 1 the signal condition analyzing unit 3 analyzes as the signal parameter of the input signal a long term signal to noise ratio lSNR. A long term signal to noise ratio lSNR is the signal to noise ratio of a group or sequence of signal frames received by the voice activity detection apparatus 1. This group of signal frames can comprise a predetermined number of signal frames, for instance 5-10 signal frames or the moving average of the signal to noise ratios of active signal frames of the received input signal. The moving average can be calculated by SNRmov=a*SNRmov+(1−a)*SNR0, where SNRmov is the moving average, SNR0 is the SNR of the latest active signal frame, a is a forgetting factor which can be 0.9 in for long term estimation.

In a still further possible implementation the signal condition analyzing unit 3 further analyzes a background noise fluctuation of the input signal to detect a signal condition and/or signal type of the received input signal. Further implementations are possible. For example the signal condition analyzing unit 3 can use other signal parameters, for example a spectrum tilt or a spectrum envelope of the received input signal.

In a possible implementation of the voice activity detection apparatus 1 as shown in FIG. 1 the voice activity detection decisions VADD provided by the voice activity detection units 4-i are formed by decision flags. The generated decision flags are combined by the decision combination unit 5 in a possible implementation of the first aspect of the present invention according to a combination logic to provide the combined voice activity detection decision cVADD which can be output by the voice activity detection apparatus 1 at signal output 6.

In a possible implementation the combination logic can be a Boolean logic combining the flags output by the voice activity detection units 4-i. In a possible embodiment the voice activity detection apparatus 1 comprises two voice activity detection units 4-1, 4-2, wherein the combination logic of the decision combination unit 5 can comprise a logic AND combination and a logic OR combination wherein the combination logic is selected depending on the signal condition SC detected by the signal condition analyzing unit 3. Accordingly, the decision combination unit 5 of the voice activity detection apparatus 1 combines the outputs of the voice activity detection units 4-i to yield the combined voice activity detection decision cVADD depending on the output control signal SC of the signal condition analyzing unit 3. In a possible implementation a combination logic or a combination strategy provided by the decision combination unit 5 includes the selection of the output of one voice activity detection unit 4-i as the final combined voice activity detection decision cVADD. Another possible combination strategy is choosing the logic OR of the outputs of more than one voice activity detection unit 4-i as the combined voice activity decision output cVADD or choosing a logic AND combination of the outputs of more than one voice activity detection unit 4-i as the combined voice activity detection output cVADD. In general, combining the decisions of the voice activity detection units 4-i based on a predetermined logic can be dependant on the output signal of the condition analyzing unit 3. A combination strategy logic can be based on the strength and weaknesses of each voice activity detection unit 4-i for each signal condition and also on a desired level of performance or the respective location of the voice activity detection apparatus 1 within the system.

For example, a logic combination by using a logical AND of different voice activity decision units 4-i leads to a more aggressive or more strict voice activity detection apparatus 1 favouring a non-detection of speech or voice since all voice activity detection units 4-i of the voice activity detection apparatus 1 have to detect that the current signal frame comprises speech. On the other hand, a logical combination OR leads to a less aggressive or more lenient voice activity detection since it is sufficient for one voice activity detection unit 4-i to detect speech in a current signal frame. Other embodiments and implementations are also possible. For example, more than two voice activity detection units 4-i can use a majority rule wherein for example a census of votes of all voice activity detection units 4-i can be used for certain signal conditions. In a possible implementation the decision combination unit 5 comprises several combination logics which can be programmed by means of a configuration interface of the voice activity detection apparatus 1.

In a further possible implementation of the voice activity detection apparatus 1 as shown in FIG. 1 the combined voice activity detection decision cVADD output by the decision combination unit 5 is also passed through a hangover process with a predetermined hangover time. This allows to smooth the voice activity detection decision and to reduce potential misqualifications associated for example by clipping at the tail of a talk spurt.

In a further possible implementation of the voice activity detection apparatus 1 according to the first aspect of the present invention a voice activity detection decision vector comprising all voice activity detection decisions of the voice activity detection units 4-i can be multiplied by a multiplication unit of said decision combination unit 5 with an adaptive or predetermined weighting matrix W to calculate the combined voice activity detection decision cVADD.

In a further possible implementation of the first aspect of the present invention a segmental signal to noise ratio SSNR vector comprising the segmental signal to noise ratios SSNRs of the voice activity detection units 4-i is multiplied with a fixed or an adaptive weighting matrix W to calculate a combined segmental signal to noise ratio value cSSNR. Further, in a possible implementation a threshold vector comprising the threshold values of the voice activity detection units 4-i is also multiplied with the adaptive weighting matrix W to calculate a combined decision threshold value. This combined decision threshold value can be compared to the calculated combined signal to noise ratio cSSNR to provide the combined voice activity detection decision cVADD output by the decision combination unit 5.

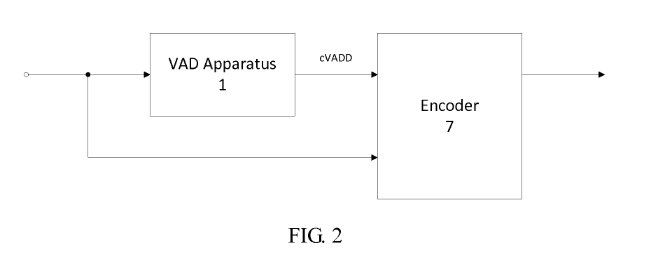

FIG. 2 shows a block diagram of an encoder 7 connected to a voice detection apparatus 1 to illustrate a second aspect of the present invention. The encoder 7 as shown in FIG. 2 can form a speech encoder provided for encoding the input signal supplied to the voice activity detection apparatus 1. As shown in FIG. 2 the encoder 7 can be controlled by the combined voice activity detection decision cVADD generated by the voice activity detection apparatus 1. The combined voice activity detection decision cVADD can comprise a label for one or several signal frames. The label can be formed by a flag describing or indicating whether a voice activity is present or not in the current signal frame or current group of signal frames. The voice activity detection apparatus 1 can operate in a possible embodiment on a frame-by-frame basis. In the shown exemplary implementation the output signal of the voice activity detection apparatus 1 controls the encoder 7. In another possible implementation the voice activity detection apparatus 1 can control other speech processing units such as a speech recognition device or it can control a speech process in an audio session. Furthermore, the voice activity detection apparatus 1 can in a possible implementation suppress unnecessary coding or transmission of data packets in voice-over-internet protocol applications, thus saving on computation and on network bandwidth. The signal processing device such as the encoder 7 as shown in FIG. 2 can form part of a speech communication device such as a mobile phone. A speech communication device can be provided within a speech communication system such as an audio conferencing system, an echo-signal cancellation system, a speech noise reduction system, a speech recognition system, a speech encoding system or a mobile phone of a cellular telephone system. The voice activity detection decision VADD can control in a possible implementation a discontinuous transmission DTX mode of an entity, for example an entity in a cellular radio system, for example a GSM or LTE or CDMA system. The provided combined voice activity detection decision cVADD of the voice activity detection apparatus 1 can enhance the system capacity of a system such as cellular radio system by reducing co-channel interference. Furthermore, the power consumption of portable digital devices within such a cellular radio system can be reduced significantly. Another possible application of the voice activity detection apparatus 1 is controlling a dialler, for example in a telemarketing application.

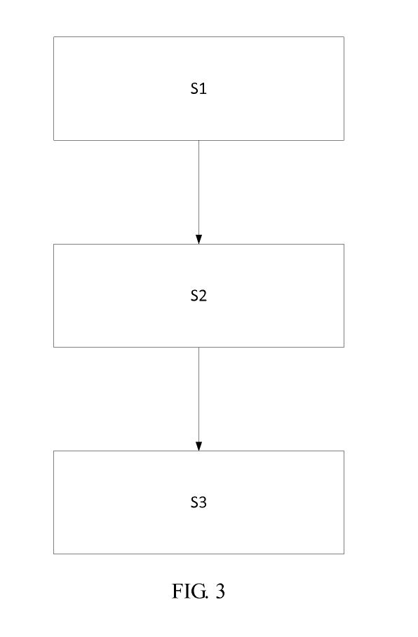

FIG. 3 shows a flow chart for illustrating an exemplary implementation of a method for performing a robust voice activity detection according to a further aspect of the present invention. In the shown implementation the method comprises three steps.

In a first step S1 at least one signal parameter and/or signal type of an input signal is analyzed to detect a signal condition of said input signal. Analyzing the signal parameter can be performed in a possible implementation by a signal condition analyzing unit 3 such as shown in FIG. 1.

In a further step S2 a voice activity detection is performed separately with at least two different voice detection characteristics to provide separate voice activity detection decisions VADDs.

In a further step S3 the voice activity detection decisions VADDs are combined depending on the detected signal condition SC to provide a combined voice activity detection decision cVADD which can be used to control a speech processing entity within a speech processing system.

The method for performing a robust voice activity detection as shown in the flow chart of FIG. 3 can be performed by executing a corresponding application program in a data processing unit such as a microcomputer. In a further possible implementation the method for performing a robust voice activity detection as shown in the flow chart of FIG. 3 can be performed by means of a hardwired circuitry. The processing of the input signal can be performed in a possible implementation in real time.

In a further specific implementation of the first aspect of the present invention the voice activity detection apparatus 1 comprises two voice activity detection units 4-1, 4-2 wherein an input audio signal applied to the voice activity detection units 4-1, 4-2 at signal input 2 can be segmented into equal signal frames each having for example 20 ms duration. In this specific implementation a first voice activity detection unit 4-1 can divide the received input frame into nine sub-frequency bands by using for example a filter bank. The sub-band energies can be calculated and denoted as EA(i) where i represents the i-th sub-band and the signal to noise ratio SNR of each sub-band is calculated by:

$${snr}_{A} ( i ) = \frac{{E}_{A} ( i )}{{E}_{An} ( i )}$$

Wherein snrA(i) represents the signal to noise ratio SNR of the i-th sub-band of the input frame, EAn(i) is the energy of the i-th sub-band of the background noise estimate and A is the index of the first activity detection unit 4-1. The sub-band energies of the background noise estimate can be estimated by a background noise estimation unit which can be contained in the first voice activity detection unit 4-1. In a possible implementation a non-linear function is applied on each estimated sub-band signal to noise ratio SNR resulting in nine modified sub-band signal to noise ratios msnrA(i). The modification can be done in a possible

$${msnr}_{A} ( i ) = MAX [ MIN [ \frac{{snr}_{A}^{2} ( i )}{25} , 1 ] \cdot {snr}_{A} ( i ) , 1 ]$$

wherein MAX [ ] and MIN [ ] represents respectively finding the maximum and the minimum among elements in the brackets. The modified sub-band signal to noise ratios SNRs are summed up in a possible implementation to obtain the segmental signal to noise ratio SSNRA of the first voice activity detection unit 4-1. The segmental signal to noise ratio SSNRA can be compared to a threshold value thrA of the first voice activity detection unit 4-1. The intermediate voice activity decision flag provided by the voice activity detection unit 4-1 can be set to 1 (meaning for example active speech detected) if the calculated segmental signal to noise ratio SSNRA exceeds the threshold value thrA, otherwise it is set to 0 (meaning for example inactive, i.e. speech not detected or background noise). The threshold thrA can be a linear function of an estimated long term signal ratio lSNR estimated for example by the first voice activity detection unit 4-1. In a possible implementation the generated intermediate voice activity decision can be passed through a hangover process to obtain a final voice activity decision for the first voice activity detection unit 4-1.

In a further possible implementation the second voice activity detection unit 4-2 can transform the received input signal frame into the frequency domain by a fast fourier transformation FFT and can divide the input frame for example into nineteen sub-frequency bands by partitioning the FFT power density bins. The sub-band energies can be calculated and are denoted by EB(i) wherein the signal to noise ratio snr of each sub-band can be calculated by:

$${snr}_{B} ( i ) = log ( \frac{{E}_{B} ( i )}{{E}_{Bn} ( i )} )$$

wherein B is the index of the second voice activity detection unit 4-2 and EB(i) is the energy of i-th sub-band of the background noise estimate which can be estimated by the second voice activity detection unit 4-2 independently from the first voice activity detection unit 4-1. In this example, the signal to noise ratio snr of each sub-band snrB(i) will be lower limited to 0.1 and upper limited to 2. Each signal to noise ratio signal snrB(i) can be applied to a non-linear function different from that used by the first voice activity detection unit 4-1 resulting in nineteenmodified sub-band signal to noise ratios msnrB(i). This modification can be done in a possible implementation by:

$${msnr}_{B} ( i ) = \{ \begin{matrix}{snr}_{B}^{9} ( i ) & {snr}_{B} ( i ) < 1 \\ {snr}_{B}^{4} ( i ) & otherwise\end{matrix}$$

The modified sub-band signal to noise ratios are summed up in a possible implementation to obtain the segmental signal to noise ratio SSNRB of the second voice activity detection unit 4-2. The generated segmental signal to noise ratio SSNRB of the second voice activity detection unit 4-2 can be compared to a threshold value thrB of the second voice activity detection unit 4-2. In a possible implementation the intermediate voice activity detection decision of the second voice activity detection unit 4-2 is set to 1 if SSNRB exceeds the corresponding threshold value thrB, otherwise it is set to 0. The threshold thrB can be a linear function of the estimated long term signal to noise ratio lSNR estimated for example by the second voice activity detection unit 4-2. The intermediate voice activity detection decision can be further passed through a corresponding hangover process being different from the hangover process used by the first voice activity detection unit 4-1 to obtain a final voice activity detection decision of the second voice activity detection unit 4-2. In a possible implementation the two voice activity detection units 4-1, 4-2 provide as the final voice activity detection decision a corresponding flag VAD FLGA, VAD FLGB. The two voice activity detection decision flags output by the voice activity detection units 4-1, 4-2 can be combined by a decision combination unit 5 according to a predetermined combination strategy or combination logic. The combination logic is selected according to the output control signal SC provided by the signal condition analyzing unit 3. In a possible implementation the signal condition SC can be formed by the estimated long term signal to noise ratio lSNR of the current input signal. This long term signal to noise ratio lSNR can be estimated independently by an independent estimation procedure. To increase efficiency of the implementation the long term signal to noise ratio lSNR can be estimated by one of the voice activity detection units 4-i.

In a possible specific implementation the long term signal to noise ratio estimate of the first voice activity detection unit 4-1 is used and categorized into three different signal to noise ratio regions, i.e. a high SNR region, a medium SNR region and a low SNR region. If the long term signal to noise ratio lSNR falls into the high signal to noise region the flag provided by the first voice activity detection unit 4-1, i.e. VAG FLGA is chosen as the final combined voice activity detection output cVADD. If the long term signal to noise ratio lSNR falls into the low SNR region the flag VAD FLGB of the second voice activity detection unit 4-2 is selected as the final combined voice activity detection decision cVADD. Furthermore, if the long term signal to noise ratio lSNR falls into the medium SNR region a logical AND combination between the two signal flags of the voice activity detection unit 4-1 and of the voice activity detection unit 4-2, i.e. VAD FLGA AND VAD FLGB is used as the final combined voice activity detection decision cVADD of the voice activity detection apparatus 1.

In a further possible implementation of the voice activity detection apparatus 1 the combination of the two voice activity detection outputs of the voice activity detection units 4-1, 4-2 is performed for the two intermediate voice activity detection outputs, i.e. without passing a corresponding hangover mechanism. An intermediate combined voice activity detection flag is then passed in a possible implementation through a hangover process to obtain the final signal output of the voice activity detection apparatus 1. The used hangover process can be in relation to any of the hangover mechanisms used by one of the voice activity detection units 4-1, 4-2 or it can be an independent hangover mechanism.

In a still further possible implementation of the voice activity detection apparatus 1 the combination processing performed by the decision combination unit 5 is implemented by matrix data processing. In this implementation the voice activity detection outputs of the two voice activity detection units 4-1, 4-2 can form a 1×2 matrix F=[VAD FLGA, VAD FLGB] wherein this matrix F is multiplied by a 2×1 weighting matrix W to obtain a combined voice activity detection indicator I. The matrix elements within the weighting matrix W can be determined by an actual long term signal to noise ratio category wherein WT=[1, 0] or [0.5, 0.5] or [0, 1] depending whether the long term signal to noise ratio lSNR falls into a high, medium or low SNR region. The combined voice activity detection flag can then be round [I+0.5]. In this implementation both intermediate, i.e. no hangover, or final results, i.e. with hangover, of the voice activity detection units 4-i can be used.

In a still further possible implementation of the voice activity detection apparatus 1 the segmental signal to noise ratio SSNRA of the first voice activity detection unit 4-1 and the segmental signal to noise ratio SSNRB of the second voice activity detection unit 4-2 can form a 1×2 matrix P=[SSNRA, SSNRB]. Furthermore, a decision threshold thrA of the first voice activity detection unit 4-1 and a decision threshold thrB of the second voice activity detection unit 4-2 can form another 1×2 matrix T=[thrA, thrB]. The two matrices in this implementation are multiplied respectively by a 2×2 weighting matrix W to obtain respectively a combined parameter cSSNR and a combined decision threshold thrM. In this implementation an intermediate voice activity decision is obtained by comparing the combined segmental signal to noise ratio SSNRM and the combined decision threshold thrM. The combined voice activity detection decision cVADD is then obtained by passing the intermediate voice activity detection decision through a hangover process. The matrix elements within the weighting matrix W can be determined by the actual long term signal to noise ratio category wherein for example WT=[1, 0] or [0.5, 0.5*(thrA/thrB)] or [0, 1] when the long term signal to noise ratio lSNR falls into the high, medium or low signal to noise ratio region. In a possible implementation the signal condition SC provided by the signal condition analyzing unit 3 can be quantized into limited steps. In a possible implementation of the voice activity detection apparatus 1 as shown in FIG. 1 the voice activity detection apparatus 1 comprises a plurality of voice activity detection units 4-i which can be software or hardware implemented, each of which is able to output voice activity decisions for each input signal frame. A set of signal conditions SC of the current input signal can be estimated by the signal condition analyzing unit 3. The voice activity detection decisions VADDs generated by the voice activity detection units 4-i can be combined to determine a final voice activity detection decision in a way among a plurality of selectable ways according to the estimated signal condition.

In a further possible implementation the voice activity detection units 4-i do not output voice activity detection flags but at least generate a pair of decision parameters and threshold values based on which the voice activity detection decision VADD can be made.

In a further possible implementation a set of signal conditions can include at least one of a long term signal to noise ratio of the input signal or the background noise fluctuation of the input signal.

In a possible implementation the voice activity detection apparatus 1 as shown in FIG. 1 can be formed by an integrated circuit. In another possible implementation of the voice activity detection apparatus 1 the apparatus can comprise several discrete elements or components connected to each other by wires. In a possible implementation of the voice activity detection apparatus 1 the voice activity detection apparatus 1 is integrated in an audio signal processing apparatus such as the encoder 7 shown in FIG. 2. In a possible implementation the voice activity detection apparatus 1 is provided for processing an electrical signal applied to the input 2. In a further possible implementation of the voice activity detection apparatus 1 processes an optical signal which is first transformed into an electrical input signal by means of a signal transformation unit. In a possible implementation the voice activity detection apparatus 1 comprises an adaptive decision combination unit 5 which is for example adaptive to a signal long term signal to noise ratio, i.e. the functions and the weighting factors used by the decision combination unit 5 are adapted to a measured long term signal to noise ratio lSNR. By means of the voice activity detection apparatus 1 according to the first aspect as shown in FIG. 1 the overall voice activity detection performance, i.e. the signal processing efficiency and accuracy as well as the detection quality can be significantly improved.

What is claimed is:

1. voice activity detection apparatus comprising:
a signal condition analyzing unit, configured to analyse at least one signal parameter of an input signal to detect a signal condition (SC) of said input signal;
at least two voice activity detection units, comprising different voice activity detection characteristics;
wherein each voice activity detection unit performs separately a voice activity detection of said input signal to provide a voice activity detection decision (VADDi); and
a decision combination unit, configured to combine the voice activity detection decisions provided by said voice activity detection units depending on the detected signal condition to provide a combined voice activity detection decision (cVADD).

2. The voice activity detection apparatus according to claim 1, wherein:
said voice activity detection apparatus comprises a signal input for receiving an input signal comprising signal frames;
said voice activity detection units are formed by signal to noise ratio (SNR)-voice activity detection units;
each signal to noise ratio (SNR)-voice activity detection unit is configured to divide an input signal frame into sub-frequency bands, calculate a signal to noise ratio for each sub-frequency band, and sum the calculated signal to noise ratios of all sub-frequency bands up to provide a segmental signal to noise ratio (SSNR) which is compared with a threshold to provide an intermediate voice activity detection decision of the respective voice activity detection unit; and
wherein the intermediate voice activity detection decision or a processed version thereof forms the voice activity detection decision.

3. The voice activity detection apparatus according to claim 2, wherein each signal to noise ratio (SNR) calculated for a corresponding sub-frequency band is modified by applying a non-linear function to the calculated signal to noise ratio (SNR) to provide a modified signal to noise ratio (mSNR), and said modified signal to noise ratios (mSNRs) are summed up by means of a adding unit to a obtain said segmental signal to noise ratio (SSNR).

4. The voice activity detection (VAD) apparatus according to claim 2, wherein the intermediate voice activity detection decision of each voice activity detection unit is passed through a hangover process with a corresponding hangover time to provide the voice activity detection decision (VADDi) of said voice activity detection unit.

5. The voice activity detection apparatus according claim 1, wherein the voice detection characteristic of each voice activity detection unit is tuneable by adapting the number of sub-frequency bands used by said voice activity detection unit and/or by changing the non-linear function used by said voice activity detection unit and/or by adapting a hangover time of the hangover process used by said voice activity detection unit.

6. The voice activity detection apparatus according to claim 1, wherein the signal condition analyzing unit is configured to analyze as the signal parameter of said input signal a long term signal to noise ratio (lSNR), a background noise fluctuation and/or an energy metric of the input signal to detect the signal condition (SC) of the input signal

7. The voice activity detection apparatus according to claim 1, wherein the voice activity detection decisions (VADDi) provided by said voice activity detection units are formed by decision flags which are combined according to a predetermined combination logic of said decision combination unit to provide the combined voice activity detection decision (cVADD) output by said voice activity detection apparatus, wherein the decision combination unit generates the combination logic based on the at least one signal parameter or the signal condition analyzed by the signal condition analyzing unit.

8. The voice activity detection apparatus according to claim 7, wherein said signal parameter analyzed by said signal condition analyzing unit is the long term signal to noise ratio (lSNR) which is categorized into three different signal to noise ratio regions comprising a high SNR region, a medium SNR region and a low SNR region; and
said combined voice activity detection decision (cVADD) is provided by said decision combination unit on the basis of the decision flags provided by said voice activity detection units depending on the SNR region in which the long term signal to noise ratio (lSNR) falls.

9. The voice activity detection apparatus according to claim 1, wherein the combined voice activity detection decision (cVADD) of said decision combination unit is passed through a hangover process with a predetermined hangover time.

10. The voice activity detection apparatus according to claim 1, wherein a voice activity detection decision vector comprising the voice activity detection decisions (VADDs) of the voice activity detection units is multiplied by said decision combination unit with an adaptive or predetermined weighting matrix to calculate the combined voice activity detection decision (cVADD).

11. The voice activity detection apparatus according to claim 1, wherein a segmental signal to noise ratio (SSNR) vector comprising the segmental signal to noise ratios (SSNRs) of the voice activity detection units is multiplied with an adaptive weighting matrix to calculate a combined segmental signal to noise ratio (cSSNR) value, and
a threshold vector comprising the threshold values of the voice activity detection units is multiplied with the adaptive weighting matrix to calculate a combined decision threshold value (cthr) which is compared to said calculated combined segmental signal to noise ratio (cSSNR) value to provide the combined voice activity detection decision (cVADD).

12. The voice activity detection apparatus according to claim 1, wherein the combined voice activity detection decision (cVADD) provided by said voice activity detection apparatus is applied to an encoder.

13. An encoder for encoding an audio signal comprising the voice activity detection apparatus according to the claim 1.

14. A speech communication device comprising a speech encoder according to claim 13.

15. A method for performing a voice activity detection of a signal comprising:
analyzing at least one signal parameter of an input signal to detect a signal condition (SC) of said input signal;
performing separately a voice activity detection (VAD) with at least two different voice detection characteristics to provide separate voice activity detection decisions (VADDi); and
combining the voice activity detection decisions (VADDi) depending on the detected signal condition (SC) to provide a combined voice activity detection decision (cVADD).
